(19) United States
(12) Patent Application Publication
(10) Pub. No.: US 2025/0288131 A1
(43) Pub. Date: Sep. 18, 2025

(54) Quick Release Watch Holder

(71) Applicant: jinventionz LLC, Albany, CA (US)

(72) Inventor: Jin Xiang Yu, Cypress, CA (US)

(21) Appl. No.: 19/078,017

(22) Filed: Mar. 12, 2025

Related U.S. Application Data
(60) Provisional application No. 63/564,389, filed on Mar. 12, 2024.

(51) Int. Cl. A47F 7/02; B63B 49/00; F16M 11/04

(52) U.S. Cl. CPC A47F 7/022; B63B 49/00; F16M 11/041

(57) ABSTRACT

A watch holder comprising a main mounting unit that has a plurality of prongs in which each prong has a central hole running through it. Each prong is designed to be placed in between a set of prongs contained on a clasp. The second set of prongs further contained a central hole. A screw is designed to traverse through the holes contained within both sets of prongs, allowing the mounting unit to be rotated about the screw for optimum positioning. The clasp is designed to be slid into position on a mounting panel that has an adhesive layer which adheres itself to the edge of a vessel.

### FIELD OF THE INVENTION

The present invention generally relates to watch holders. More specifically, the present invention is a quick release watch holder for aquatic vessels.

### BACKGROUND OF THE INVENTION

Often times one may need a GPS or a device for providing metrics while operating an aquatic vessel. A smart watch is an apparatus with advance technology built into them that is capable of providing these metrics to the operator of a boat. However, if one does not want the watch on their wrist, they opt to take the watch off and place it on the dash panel of a boat. Unfortunately, if one still wants the watch accessible to be able to view these metrics on command, there is no steady surface to place the watch on. The waves crashing against the side of the boat will cause the boat to rock, in turn causing the watch to slide about, making it hard to view these important metrics.

An objective of the present invention is to provide a stand for a watch to be placed upon while operating the aquatic vessel. The stand is attached by way of a rotating hinge to a panel equipped with an adhesive pad on the underside of the flat panel. The adhesive panel is then mounted to the sidewall of any boat or any surface capable of having an adhesive layer attached to it.

### BRIEF DESCRIPTION OF THE DRAWINGS

FIG. 1 shows a top=front-right view of the present invention.

FIG. 2 shows a front view of present invention.

FIG. 3 is a rear view of the present invention.

FIG. 4 is a left-bottom-front view of the present invention.

FIG. 5 is a bottom view of the present invention.

FIG. 6 is a top view of the present invention.

FIG. 7 is a right view of the present invention.

FIG. 8 is a left view of the present invention.

FIG. 9 is a right-front-bottom view of the mounting unit of the present invention.

FIG. 10 is a top-left-front view of the clasp of present invention.

FIG. 11 is a front view of the present invention with the mounting unit removed.

### DETAILED DESCRIPTION OF THE INVENTION

All illustrations of the drawings are for the purpose of describing selected versions of the present invention and are not intended to limit the scope of the present invention.

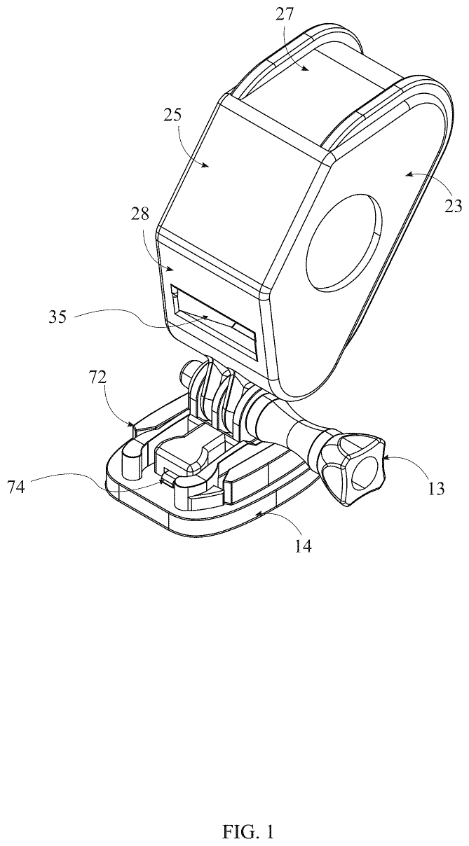

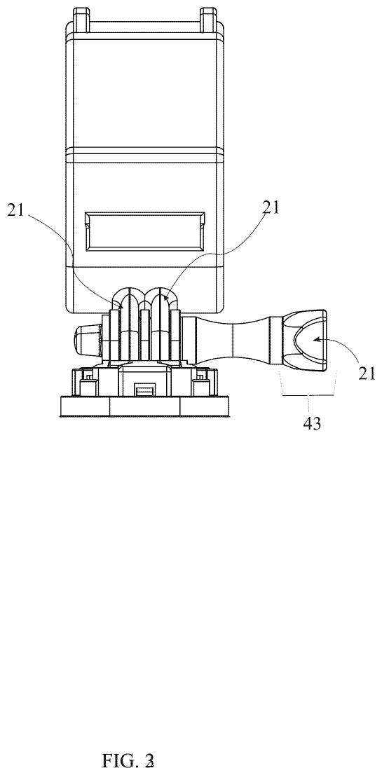

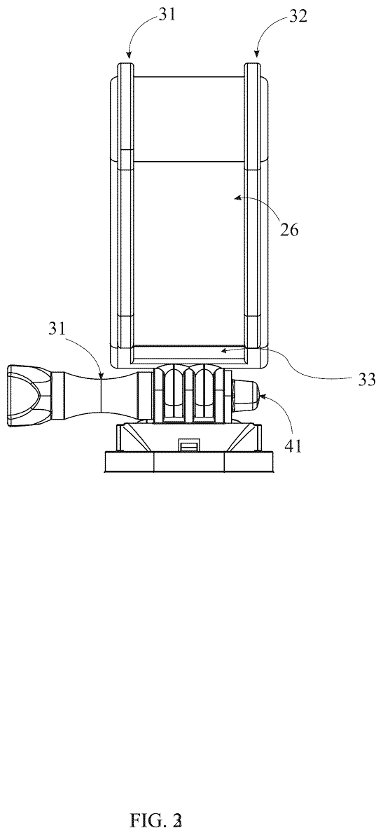

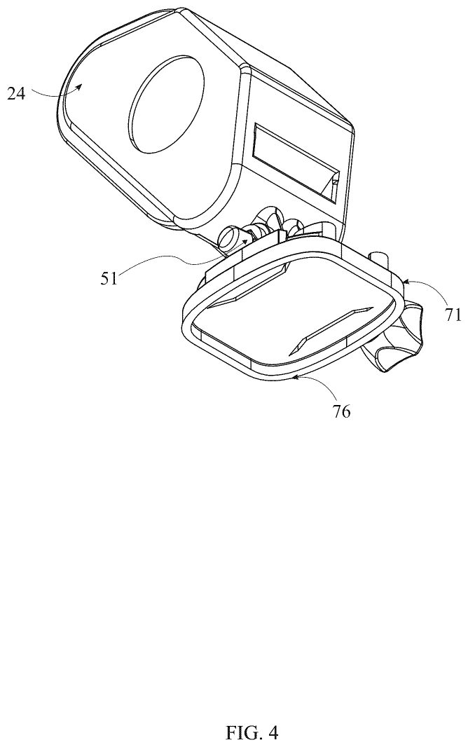

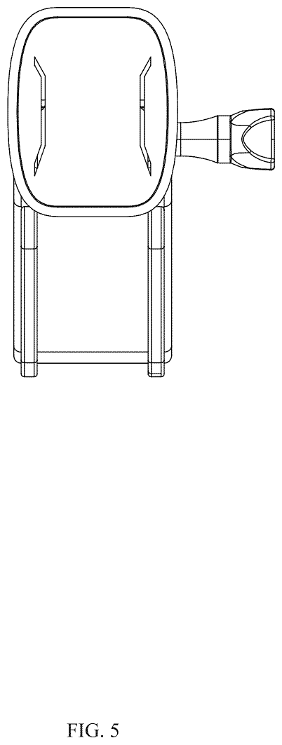

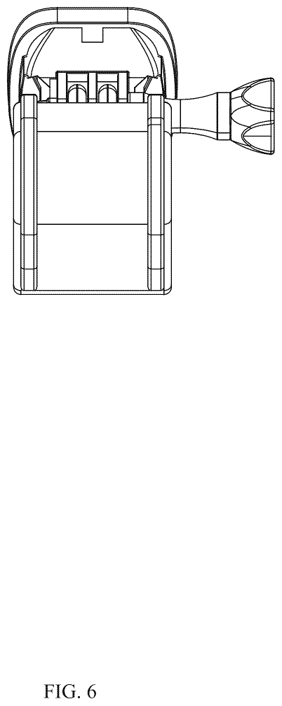

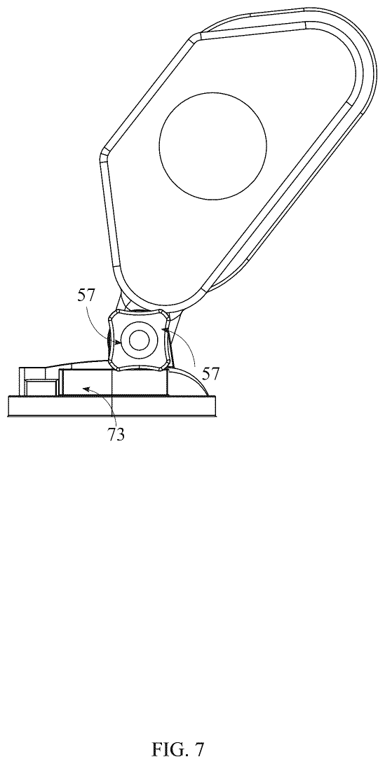

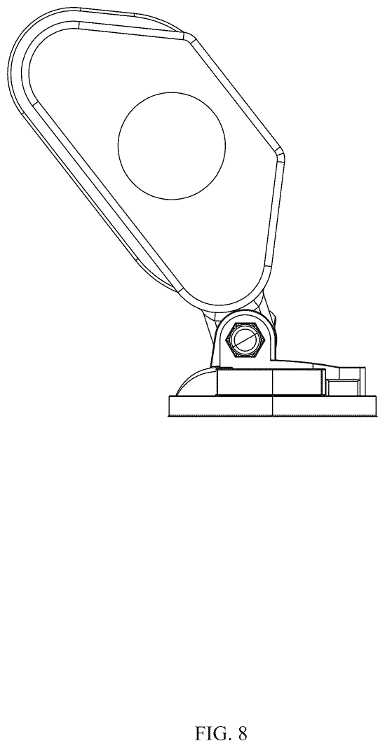

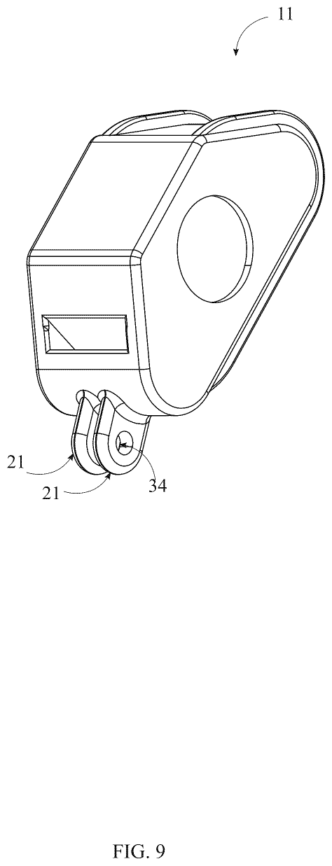

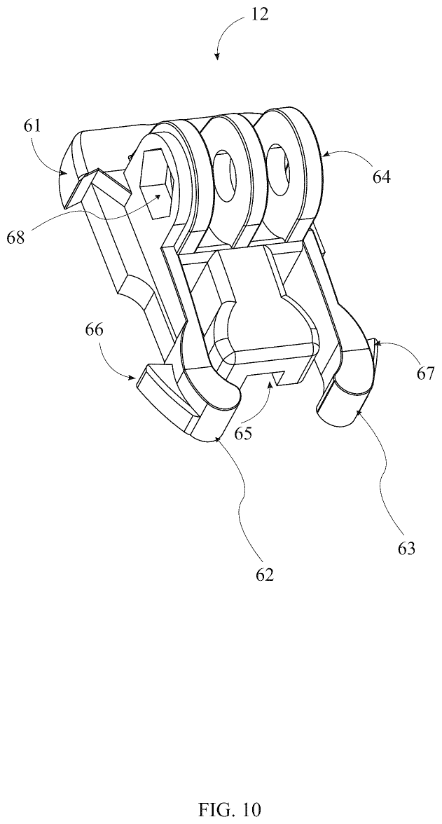

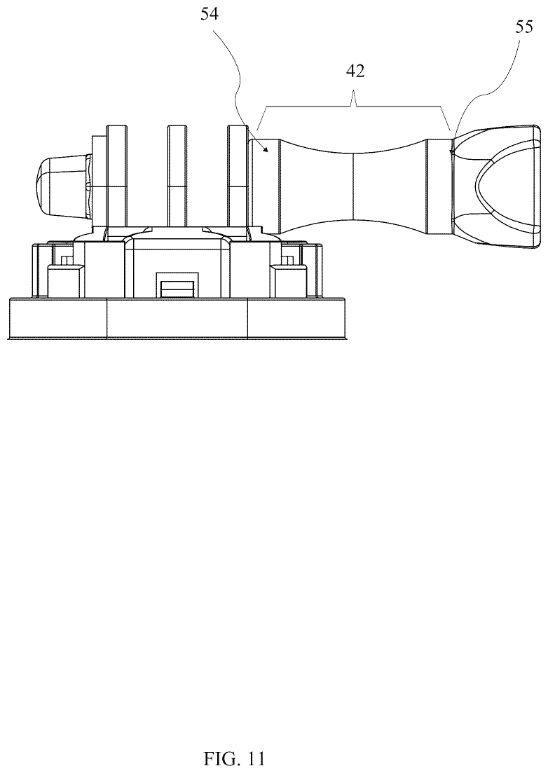

As can be seen in FIGS. 1 through 11, the present invention is a watch stand that is capable of being securely attached to the side rail or any flat surface of a boat or other aquatic vessel. The design has a central body that is oblong in shape while also maintaining a rounded appearance. This rounded appearance is necessary as it allows for a watch to be securely positioned around the invention. The central body is connected to a clip by way of a hinge.

The quick release watch holder has a mounting unit 11. It is the mounting unit 11 that bears the oblong rounded shape. The mounting unit 11 is hollowed out inside. This hollowed out mounting unit 11 allows the quick release watch holder to be lightweight which allows it to float. Having the watch release be capable of floating proves beneficial should the watch release ever go overboard. One will never have to worry about losing their watch or the watch stand as it can quickly be scooped up out of the water.

The mounting unit 11 comprises a first outer wall 23 and a second outer wall 24. The mounting unit 11 further comprises a front face 25 and a rear face 26. The front fact is a front four sided panel that allows the watch face to rest flush with the front face 25 to remain secure and not slide about the mounting unit 11. The mounting unit 11 further comprises a top face 27 and a bottom face 28. The top face 27 is positioned between the front face 25 and the rear face 26 and the bottom face 28 is positioned between the front face 25 and the rear face 26 opposite the top face 27.

To further assist in keeping the watch in place on the mounting unit 11 are a right barrier 32 and a left barrier 31. The right barrier 32 and the left barrier 31 are similar to a lip that ensure that the watch strap stays in position on the mounting unit 11. The left barrier 31 traversing the first edge of the top face 27, the first edge of the rear face 26 and the first edge of the bottom face 28. Similarly, the right barrier 32 traversing the second edge of the top face 27, the second edge of the rear face 26 and the second edge of the bottom face 28.

The bottom face 28 has a bottom aperture 35 and the rear face 26 has a rear aperture 33. These two apertures allow watch strap to be inserted through the bottom aperture 35 and exit out the rear aperture 33 to be connected to the other side of the watch strap. It is threaded through and can be connected to the other part of the watch strap that travels up and over to the rear face 26 of the mounting unit 11 securing the watch in place.

The bottom face 28 has a first edge and a second edge and the rear face 26 has a first edge and a second edge. The front face 25 has a first edge and a second edge and the top face 27 has a first edge and a second edge.

The base panel 14 is comprised of an adhesive layer 75 and a mounting panel 71. The base panel 14 further comprises a top side and an underside. The adhesive layer 75 is adhered to the underside of the mounting panel 71. The adhesive layer 75 is the bottom most surface and comes in direct contact with the surface the quick release watch stand is secured to. The base panel 14 comprises a left edge and a right edge. A left latching wall 72 is centrally positioned on the left edge and a right latching wall 73 is centrally positioned along the right edge of the base panel 14. The left latching wall 72 and right latching wall 73 is what makes contact with the clasp 12 along with a left latching wing 66 and a right latching wing 67 of the clasp 12. When the clasp 12 is slid into position within the mounting panel 71, the latching walls aid in keeping the clasp 12 in position.

A central support rail 74 is centrally positioned on the top side of the mounting panel 71. This central support rail 74 extends upward from the mounting panel 71 and is designed to fit within a central support trough 65 on the underside of the clasp 12, further ensuring the clasp 12 remains in position when in use and does not become loose.

The clasp 12 has a main body 61 portion and a left arm 62 and a right arm 63. The left arm 62 and the right arm 63 are flexible arms that extend upward in the same direction as one another. The left arm 62 comprises a left latching wing 66 and the right arm 63 comprises a right latching wing 67. As the wings extend outward from the flexible arms, when the clasp 12 is in position, the wings will rest on the left latching wall 72 and the right latching wall 73. To release the clip from its position, the wings are depressed inward, causing the flexible arms to be fully contained within the channel, and the clasp 12 can be slid out of the base panel 14. The clasp 12 comprises a central support trough 65 which traverses the length of the underside of the main body 61 of the clasp 12.

A thumb screw 13 is comprised of a cap 41, a shaft, and a head 43. The shaft 42 comprises an internal end 54 and an external end 55 connected by a concave stem 56. The head 43 is comprised of a plurality of sides 57. Each of the plurality of sides 57 comprises a finger divot 58, which allows for better grip on the thumb screw 13. The cap 41 further comprises a cylindrical body 51, a seal 52, and a top panel 53. The seal 52 is perimetrically positioned around the cylindrical body 51 and the top panel 53 is positioned about the cylindrical body 51 opposite the seal 52.

There are two sets of prongs to the quick release watch holder. The watch holder comprises a plurality of clasping prongs 64. The plurality of clasping prongs 64 extend upward from the clasp 12. A middle aperture traverses through each of the plurality of clasping prongs 64. A plurality of mounting prongs 21 extend downward from the bottom face 28 and each of the plurality of mounting prongs 21 comprising a central aperture 34. The mounting prongs 21 and the clasping prongs 64 are designed be slidably positioned next to one another to allow a screw to be inserted, by way of the thumb screw 13 to hold the mounting until to the clasp 12. When in position, it allows the mounting unit 11 to be rotably moved about the screw.

Although the invention has been explained in relation to its preferred embodiment, it is to be understood that many other possible modifications and variations can be made without departing from the spirit and scope of the invention.

What is claimed is:

1. A watch holder comprising:
a mounting unit;
a base panel;
the mounting unit comprising a first outer wall and a second outer wall;
the mounting unit further comprising a front face and a rear face;
a top face being positioned between the front face and the rear face; and
a bottom face being positioned between the front face and the rear face opposite the top face;
a plurality of mounting prongs extending downward from the bottom face; and
each of the plurality of mounting prongs comprising a central aperture.

2. The watch holder as in claim 1:
the bottom face having a first edge and a second edge;
the rear face having a first edge and a second edge;
the front face having a first edge and a second edge; and
the top face having a first edge and a second edge.

3. The watch holder as in claim 2 comprising:
the bottom face comprising a bottom aperture; and
the rear face comprising a rear aperture;
a left barrier traversing the first edge of the top face, the first edge of the rear face and the first edge of the bottom face;
a right barrier traversing the second edge of the top face, the second edge of the rear face and the second edge of the bottom face.

4. The watch holder as in claim 1 comprising:
a base panel;
the base panel comprising a mounting a panel and a layer of adhesive;
the base panel comprising a top side and an underside;
the base panel comprising a left edge and a right edge;
the layer of adhesive being adhered to the underside of the mounting panel;
a central support rail being centrally positioned on the top side of the mounting panel;
a left latching wall being centrally positioned on the left edge; and
a right latching wall being centrally positioned on the right edge.

5. The watch holder as in claim 1 comprising:
a clasp;
the clasp comprising a main body, a left arm, and a right arm;
the left arm further comprising a left latching wing;
the right arm further comprising a right latching wing;
the right latching wing extending outward from the right arm; and
the left latching wing extending outward from the left arm;
and a central securement trough traversing the length of the underside of the main body.

6. The watch holder as in claim 5 comprising:
a plurality of clasping prongs;
the plurality of clasping prongs are positioned about the clasp and extend upward; and
a middle aperture traversing through each of the plurality of clasping prongs.

7. The watch holder as in claim 1 comprising
a thumb screw;
the thumb screw comprising a cap, a shaft, and a head;
the shaft comprising an internal end and an external end;
a concave stem being positioned between the internal end and external end;
the head comprising a plurality of sides;
each of the plurality of sides comprising a finger divot.

8. The watch holder as in claim 7 comprising:
The cap further comprising a cylindrical body, a seal, and a top panel;
the seal being perimetrically positioned around the cylindrical body; and
the top panel being positioned about the cylindrical body opposite the seal.

9. A watch holder comprising:
a mounting unit;
a base panel;
the mounting unit comprising a first outer wall and a second outer wall;
the mounting unit further comprising a front face and a rear face;
a top face being positioned between the front face and the rear face; and
a bottom face being positioned between the front face and the rear face opposite the top face;
a plurality of mounting prongs extending downward from the bottom face;
each of the plurality of mounting prongs comprising a central aperture;
the bottom face having a first edge and a second edge;
the rear face having a first edge and a second edge;
the front face having a first edge and a second edge; and
the top face having a first edge and a second edge.

10. The watch holder as in claim 9 comprising:
the bottom face comprising a bottom aperture;
the rear face comprising a rear aperture;
a left barrier traversing the first edge of the top face, the first edge of the rear face and the first edge of the bottom face;
a right barrier traversing the second edge of the top face, the second edge of the rear face and the second edge of the bottom face;
a base panel;
the base panel comprising a mounting a panel and a layer of adhesive;
the base panel comprising a top side and an underside;
the base panel comprising a left edge and a right edge;
the layer of adhesive being adhered to the underside of the mounting panel;
a central support rail being centrally positioned on the top side of the mounting panel;
a left latching wall being centrally positioned on the left edge; and
a right latching wall being centrally positioned on the right edge.

11. The watch holder as in claim 9:
a clasp;
the clasp comprising a main body, a left arm, and a right arm;
the left arm further comprising a left latching wing;
the right arm further comprising a right latching wing;
the right latching wing extending outward from the right arm;
the left latching wing extending outward from the left arm;
and a central securement trough traversing the length of the underside of the main body;
a plurality of clasping prongs;
the plurality of clasping prongs are positioned about the clasp and extend upward; and
a middle aperture traversing through each of the plurality of clasping prongs.

12. The watch holder as in claim 11 comprising:
a thumb screw;
the thumb screw comprising a cap, a shaft, and a head;
the shaft comprising an internal end and an external end;
a concave stem being positioned between the internal end and external end;
the head comprising a plurality of sides;
each of the plurality of sides comprising a finger divot;
the cap further comprising a cylindrical body, a seal, and a top panel;
the seal being perimetrically positioned around the cylindrical body; and
the top panel being positioned about the cylindrical body opposite the seal.

13. The watch holder as in claim 12 comprising:
a mounting unit;
a base panel;
the mounting unit comprising a first outer wall and a second outer wall;
the mounting unit further comprising a front face and a rear face;
a top face being positioned between the front face and the rear face; and
a bottom face being positioned between the front face and the rear face opposite the top face;
a plurality of mounting prongs extending downward from the bottom face;
each of the plurality of mounting prongs comprising a central aperture;
the bottom face having a first edge and a second edge;
the rear face having a first edge and a second edge;
the front face having a first edge and a second edge; and
the top face having a first edge and a second edge;
the bottom face comprising a bottom aperture;
the rear face comprising a rear aperture;
a left barrier traversing the first edge of the top face, the first edge of the rear face and the first edge of the bottom face;
a right barrier traversing the second edge of the top face, the second edge of the rear face and the second edge of the bottom face;
a base panel;
the base panel comprising a mounting a panel and a layer of adhesive;
the base panel comprising a top side and an underside;
the base panel comprising a left edge and a right edge;
the layer of adhesive being adhered to the underside of the mounting panel;
a central support rail being centrally positioned on the top side of the mounting panel;
a left latching wall being centrally positioned on the left edge; and
a right latching wall being centrally positioned on the right edge.

14. The watch holder as in claim 11 comprising
a clasp;
the clasp comprising a main body, a left arm, and a right arm;
the left arm further comprising a left latching wing;
the right arm further comprising a right latching wing;
the right latching wing extending outward from the right arm;
the left latching wing extending outward from the left arm;
and a central securement trough traversing the length of the underside of the main body;
a plurality of clasping prongs;
the plurality of clasping prongs are positioned about the clasp and extend upward; and
a middle aperture traversing through each of the plurality of clasping prongs;
a thumb screw;
the thumb screw comprising a cap, a shaft, and a head;
the shaft comprising an internal end and an external end;
a concave stem being positioned between the internal end and external end;
the head comprising a plurality of sides;
each of the plurality of sides comprising a finger divot;
the cap further comprising a cylindrical body, a seal, and a top panel;
the seal being perimetrically positioned around the cylindrical body; and
the top panel being positioned about the cylindrical body opposite the seal.
